(19) United States
(12) Patent Application Publication
(10) Pub. No.: US 2015/0190924 A1
(43) Pub. Date: Jul. 9, 2015

(54) LINK-LOCK POWER WORK DEVICE, COMPONENTS THEREOF, AND METHODS OF MAKING AND USING THE SAME

(71) Applicant: Tech Rim Standards, LLC, Auburn Hills, MI (US)

(72) Inventors: Todd M. Clees, Grand Blanc, MI (US); Marek P. Bieciuk, Shelby Township, MI (US)

(73) Assignee: Tech Rim Standards, LLC, Auburn Hills, MI (US)

(21) Appl. No.: 14/146,939

(22) Filed: Jan. 3, 2014

(51) Int. Cl. B25J 9/04; B25J 19/00; B25J 19/06; F16H 21/44

(52) U.S. Cl. CPC B25J 9/04; F16H 21/44; B25J 19/0091; B25J 19/06

(57) ABSTRACT

A number of variations may include a link-lock power work device, components thereof and methods of making and using the same.

### TECHNICAL FIELD

The field to which the disclosure generally relates to includes power work devices which may include a power work arm and at least one shock absorber, components thereof, and methods of making and using the same.

### BACKGROUND

McNamara U.S. Pat. No. 5,216,930 discloses a power arm, and McNamara U.S. Pat. No. 5,875,678 discloses a power work arm with dual shock action shock absorber.

### SUMMARY OF ILLUSTRATIVE VARIATIONS

A number of variations may include a link-lock power work device, components thereof, and methods of using and making the same.

Other illustrative variations within the scope of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a prospective view of a link-lock power work device according to a number of variations.

FIG. 2 illustrates a prospective view of a link-lock base assembly according to a number of variations.

FIG. 3 illustrates a front view of a side plate according to a number of variations.

FIG. 4 illustrates a side view of a side plate according to a number of variations.

FIG. 5 illustrates a front view of a side plate according to a number of variations.

FIG. 6 illustrates a side view of a side plate according to a number of variations.

FIG. 7 illustrates a prospective view of a base plate according to a number of variations.

FIG. 8 illustrates a top view of a base plate according to a number of variations.

FIG. 9 illustrates a side view of a base plate according to a number of variations.

FIG. 10 illustrates a prospective view of a spacer block according to a number of variations.

FIG. 11 illustrates a side view of a spacer block according to a number of variations.

FIG. 12 illustrates a prospective view of a spacer block according to a number of variations.

FIG. 13 illustrates a side view of a spacer block according to a number of variations.

FIG. 14 illustrates a prospective view of a link plate according to a number of variations.

FIG. 15 illustrates a prospective view of a shaft according to a number of variations.

FIG. 16 illustrates a prospective view of a housing side plate according to a number of variations.

FIG. 17 illustrates a prospective view of an angle bracket according to a number of variations.

FIG. 18 illustrates a top view of an angle bracket with a mounting plate, shock absorber, and mounting block according to a number of variations.

FIG. 19 illustrates a close-up prospective view of a power work device according to a number of variations.

FIG. 20 illustrates a prospective view of a link plate according to a number of variations.

FIG. 21 illustrates a prospective view of a connector according to a number of variations.

FIG. 22 illustrates a rear view of a connector according to a number of variations.

FIG. 23 illustrates a link-lock assembly according to a number of variations.

FIG. 24 illustrates a link-lock assembly according to a number of variations.

FIG. 25 illustrates a prospective front view of a power work device according to a number of variations.

FIG. 26 illustrates a prospective view of a work arm assembly according to a number of variations.

FIG. 27 illustrates a prospective view of a stop arm assembly according to a number of variations.

FIG. 28 illustrates a prospective view of a link-lock power work device according to a number of variations.

FIG. 29 illustrates a prospective view of a link-lock power work device according to a number of variations.

FIG. 30 illustrates a prospective view of a link-lock power work device according to a number of variations.

FIG. 31 illustrates a prospective view of a link-lock power work device according to a number of variations.

FIG. 32 illustrates a prospective view of a side plate according to a number of variations.

FIG. 33 illustrates a prospective view of a support bracket according to a number of variations.

FIG. 34 illustrates a prospective view of a connector according to a number of variations.

FIG. 35 illustrates a prospective view of a link-lock power work device according to a number of variations.

FIG. 36 illustrates a prospective view of a link-lock power work device according to a number of variations.

FIG. 37 illustrates a prospective view of a link-lock power work device according to a number of variations.

FIG. 38 illustrates a prospective view of a link-lock power work device according to a number of variations.

### DETAILED DESCRIPTION OF ILLUSTRATIVE VARIATIONS

The following description of the variations is merely illustrative in nature and is in no way intended to limit the scope of the invention, its application, or uses.

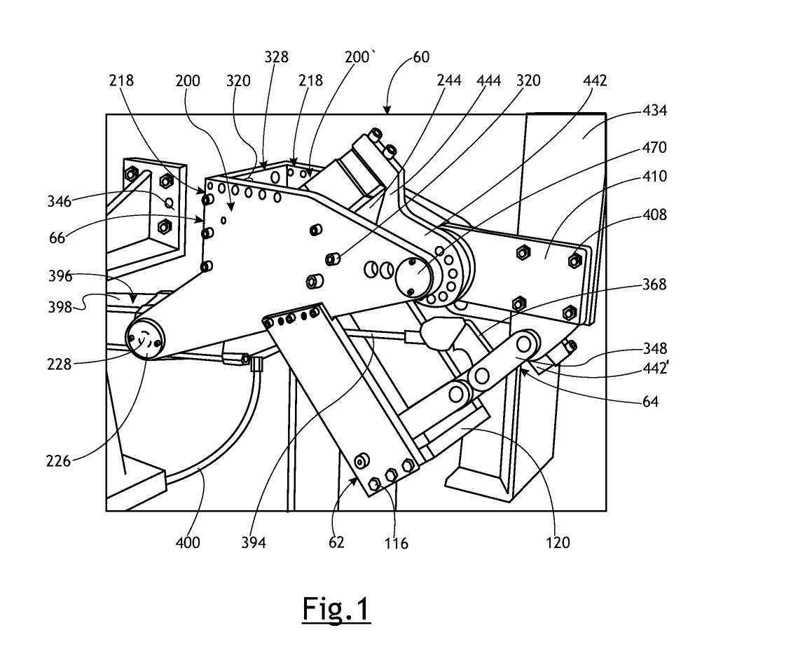

Referring to FIG. 1, a link-lock power work device 60 may include a link-lock base assembly 62, a link-lock work assembly 64, and a housing assembly 66.

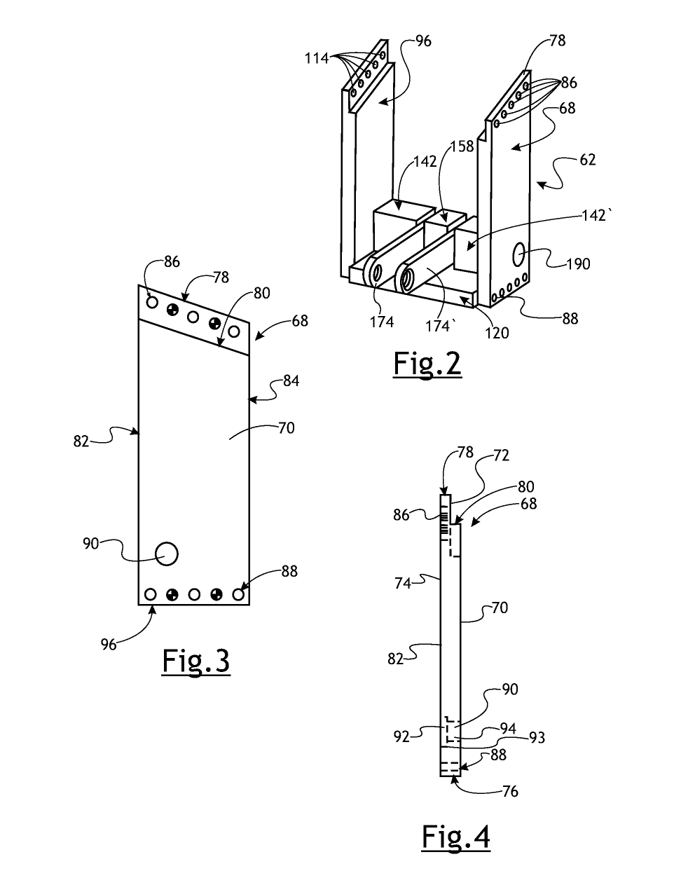

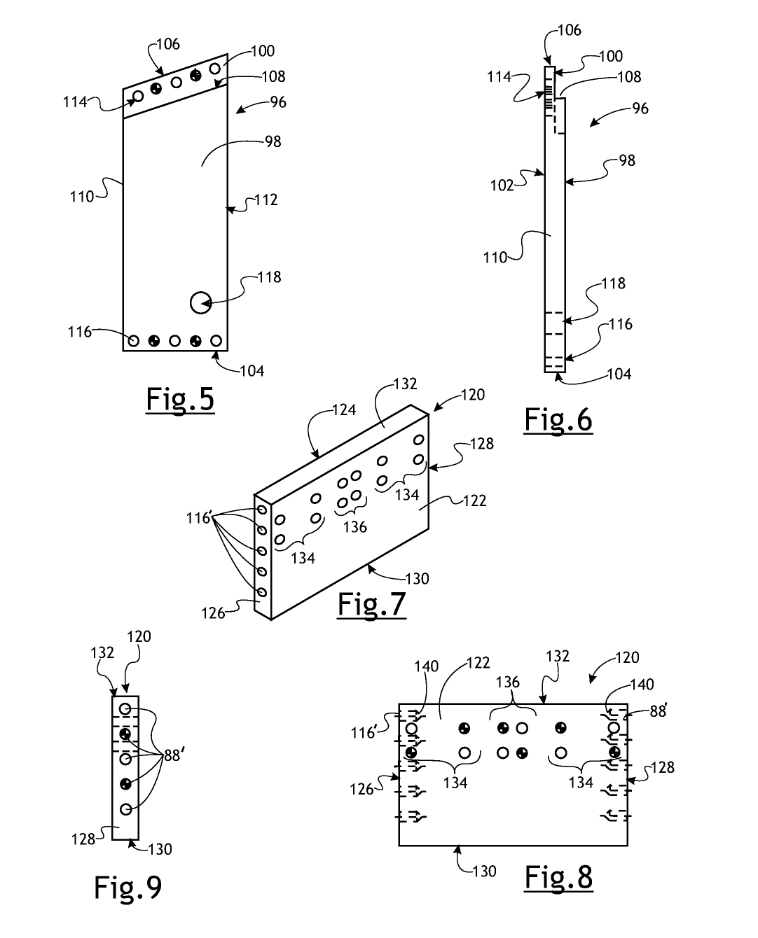

Referring to FIGS. 2-6, in any of a number of variations, a link-lock base assembly 62 may include a first side plate 68, a second side plate 96, a base plate 120, a first spacer block 142, a second spacer block 142′, a third spacer block 158, a first link plate 174, a second link plate 174′, and a shaft 190.

In any of a number of variations, a first side plate 68 may include a first front face 70, a second front face 72, a rear face 74, a bottom face 76, a first top face 78, a second top face 80, a first side face 82, and a second side face 84, for example as illustrated in FIGS. 2-4. The first top face 78 and second top face 80 may angle or slope downward so that the first side face 82 may be greater in length than the second side face 84. A first set of through-holes 86 may extend through the second front face 72 to the rear face 74. The first set of through-holes 86 may be evenly spaced out along the same angled plan and may be configured so that they align with a plurality of holes on the first housing side plate, which will be described hereafter. The first set of through-holes 86 may each be constructed and arranged to accommodate a mechanical fastener, including, but not limited to, a bolt. A second set of though-holes 88 may also extend through the first front face 70 to the rear face 74 adjacent the bottom face 76 and may be evenly spaced along the same horizontal plan. The second set of through-holes 88 may be configured so that they align with a plurality of holes on a base plate which will be described hereafter. The second set of though-holes 88 may each be constructed and arranged to accommodate a mechanical fastener, including, but not limited to, a bolt. A shaft hole 90 may also extend through the first front face 70 and the rear face 74. The shaft hole 90 may be adjacent the first side face 82 and bottom face 76. The shaft hole 90 may include a first cylindrical surface 92 having a first diameter and a second cylindrical surface 94 having a second diameter, and a lip 93 which may be constructed and arranged to accept a shaft, as will be described hereafter. The diameter of the first cylindrical surface 92 may be larger than the diameter of the second cylindrical surface 94, as illustrated in FIG. 4. The first diameter 92 may extend less than half of the width of the first side face 82 and second side face 84. The second diameter 94 may extend more than half of the width of the first side face 82 and the second side face 84.

In any of a number of variations, a second side plate 96 may include a first front face 98, a second front face 100, a rear face 102, a bottom face 104, a first top face 106, a second top face 108, a first side face 110, and a second side face 112, for example as illustrated in FIGS. 2, and 5-6. The first top face 106 and second top face 108 may angle or slope downward so that the second side face 112 may be greater in length than the first side face 110. A first set of though holes 114, may extend through the second front face 100 to the rear face 102. The first set of through-holes 114 may be evenly spaced out along the same angled plan and may be configured so that they align with a plurality of holes located on a second housing side plate, which will be discussed hereafter. The first set of through-holes 114 may each be constructed and arranged to accommodate a mechanical fastener, for example, but not limited to, a bolt. A second set of through-holes 116 may also extend through the first front face 98 to the rear face 102 adjacent the bottom face 104. The second set of through-holes 116 may be configured so that they align with a plurality of holes on a base plate which will be discussed hereafter. The second set of though holes 116 may be evenly spaced along the same horizontal plan and may be constructed and arrange to accommodate at least one mechanical fastener including, but not limited to, a bolt. A shaft hole 118 may also extend through the first front face 98 and the rear face 102. The shaft hole 118 may be adjacent the second side face 112 and bottom face 104. The shaft hole 118 may be any of a number of diameters in order to accommodate a shaft, which will be discussed hereafter.

Referring to FIGS. 2, and 7-9, in any of a number of variations, a base plate 120 may include a top face 122, a bottom face 124, a first side face 126, a second side face 128, a front face 130, and a rear face 132. The base plate 120 may include a first set of through-holes 134 which may extend through the top face 122 to the bottom face 124 and may be adjacent the rear face 132 and first side face 126 and a third set of through-holes 134 which may be adjacent the rear face 132 and second side face 128, and which may be configured so that they align with a plurality of holes located on a first or third spacer block as will be discussed hereafter. A second set of through-holes 136 may extend through the top face 122 and the bottom face 124 adjacent the rear face and the first set of through-holes 134 and may be configured so that they align with a plurality of holes located on a second spacer block as will be described hereafter. The through-holes 134, 136 may each also be constructed and arranged to accommodate a mechanical fastener including, but not limited to, a bolt.

A fourth set of mounting holes 116′ may also extend a distance through the first side face 126 and may include a tapered end 140, for example as illustrated in FIG. 8. The fourth set of mounting holes 116′ may be configured to align with the second set of mounting holes 116 on the second side plate 96. The fourth set of mounting holes 116′ may each be constructed and arranged to accommodate a mechanical fastener, for example, but not limited to, a bolt. A fifth set of mounting holes 88′ may also extend a distance through the second side face 128 and may include a tapered end 140, for example as illustrated in FIG. 8. The fifth set of mounting holes 88′ may be configured so that they align with the second set of mounting holes 88 on the first side plate 98. The fifth set of mounting holes 88′ may each be constructed and arranged to accommodate a mechanical fastener, for example, but not limited to, a bolt.

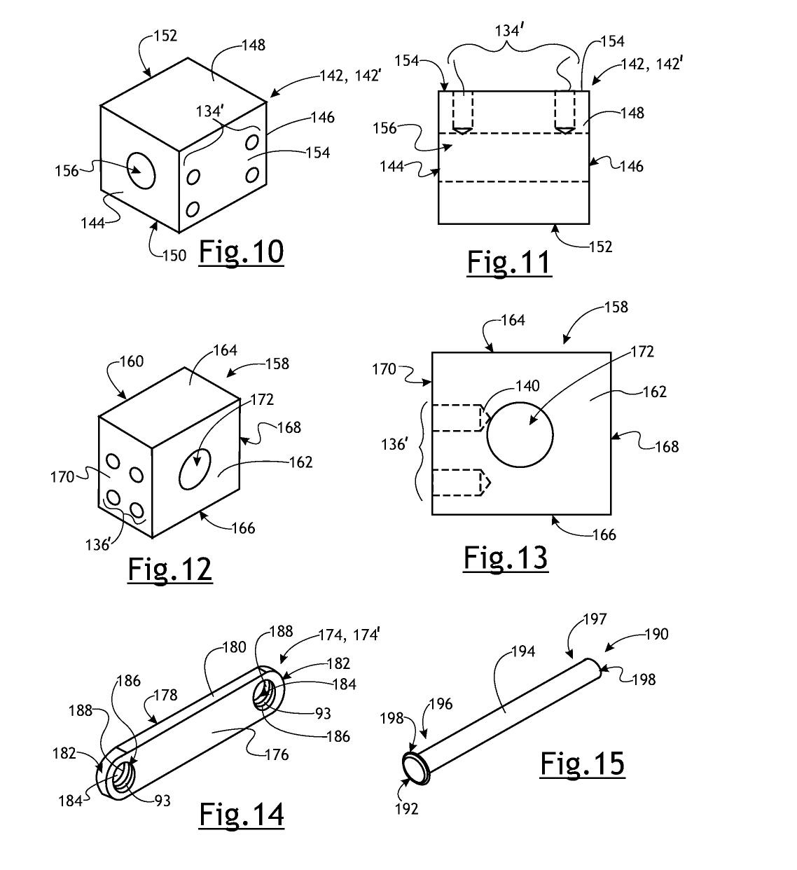

Referring to FIGS. 2 and 10-11, in any of a number of variations, a first spacer block 142 and second spacer block 142′ may each include a first side face 144, a second side face 146, a front face 148, a rear face 150, a top face 152, and a bottom face 154 which may form a box-like shape. A shaft through-hole 156 may extend through the first side face 144 to the second side face 146. The shaft through-hole 156 may be constructed and arranged to accommodate a shaft as will be discussed hereafter. The bottom face 154 may include a set of mounting holes 134′ which may extend a distance into each of the first and second spacer blocks 142, 142′ and may each include a tapered end 140, for example as illustrated in FIG. 11. The set of mounting holes 134′ may be configured to align with both the first and third set of through-holes 134 located on the base plate 120, for example as illustrated in FIG. 2.

Referring to FIGS. 2, and 12-13, in any of a number of variations, a third spacer block 158 may include a first side face 160, a second side face 162, a front face 164, a rear face 166, a top face 168, and a bottom face 170 which may form a box-like shape. A shaft through-hole 172 may extend through the first side face 160 to the second side face 162. The shaft through-hole 172 may be constructed and arranged to accommodate a shaft, as will be discussed hereafter. The bottom face 170 may include a set of mounting holes 136′ which may extend a distance into the third spacer block 158 and may include a tapered end 140, for example as illustrated in FIG. 13. The set of mounting holes 136′ may be configured to align with the second set of through-holes 136 located on the base plate 120, for example as illustrated in FIG. 2.

Referring to FIG. 14, in any of a number of variations, a first and second link plate 174, 174′ may each include a first face 176, a second face 178, and a side face 180. The first and second faces 176, 178 may each include a rounded end 182. A through-hole 184 may be located on each end 182 of the first and second link plates 174, 174′ and may extend through the first face 176 and the second face 178. The through-hole 184 may include a first cylindrical surface 186 having a first diameter and a second cylindrical surface 188 having a second diameter. The first cylindrical surface 186 may be adjacent the first face 176 and may extend approximately halfway into the link plate 174, 174′. The second cylindrical surface 188 may be adjacent the second face 178 and may also extend approximately halfway into the link plate 174, 174′. The diameter of the first cylindrical surface 186 may be greater than the diameter of the second cylindrical surface 188. The through-holes 184 may each be constructed and arranged to accommodate a shaft as discussed hereafter.

Referring to FIGS. 4 and 15, in any of a number of variations, a link-lock assembly shaft 190 may include a shaft head 192 and a shaft body 194. The shaft head 192 may be circular and may also include a taper 198 as it extends away from the shaft body 194. The shaft head 192 may be constructed and arranged to mate with the first cylindrical surface 186 on the first housing side plate 68, for example as illustrated in FIG. 4. The shaft head 192 may include a diameter greater than the shaft body 194. The first end 196 of the shaft body 194 may be attached to a shaft head 192. The shaft body 194 may be cylindrical and may include a taper 198 at the second end 197.

Referring to FIG. 2, a link-lock base assembly 62 may be assembled by attaching a first side plate 68, a second spacer block 142′, a second link 174′, a third spacer block 158, a first link 174, a first spacer block 142, and a second side plate 96 onto the link-lock assembly shaft 190.

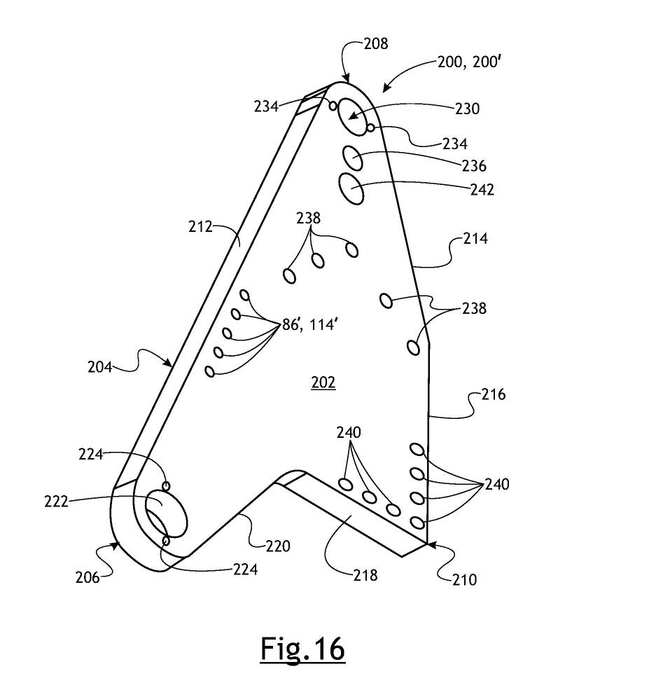

Referring to FIG. 1, in any of a number of variations, the link-lock base assembly 62 may be attached to a housing assembly 66. Referring to FIGS. 16-19, in any of a number of variations, a housing assembly 66 may include a first and second housing side plate 200, 200′, an angle bracket 244, a shock absorber 326, a support plate 328, and a shock mounting block 280.

Referring to FIGS. 2 and 16, in any of a number of variations, a first and second housing side plate 200, 200′ may each include a first face 202 and an opposite second face 204. The first face 202 and second face 204 may include a first corner 206 which may be rounded, a second corner 208 which may also be rounded, and a third corner 210. In one variation, the third corner 210 may form a right angle. A first side edge 212 may extend from the first corner 206 to the second corner 208. A second side edge 214 may extend from the second corner 208 and may meet a third side edge 216. The second side edge 214 and third side edge 216 may be formed at an obtuse angle. A fourth side edge 218 may extend from the third corner 210 and engage a fifth side edge 220 extending from the first corner 206. A pivot rod through-hole 222 may be formed in the first and second housing side plates 200, 200′ at the first corner 206 and a pair of mounting holes 224 may be formed in the first face 202 of the first and second housing side plates 200, 200′ adjacent the pivot rod through-hole 222 to facilitate attachment of a pivot rod cap to a pivot rod extending through the pivot rod through-hole and connected to an actuator as described hereafter. A shaft through-hole 230 may be formed in the first and second housing side plates 200, 200′ near the second corner 208 to facilitate a shaft which may extend there through and through a first and second stop arm, a work arm, and one or more spacers if desired, which will be discussed hereafter. A pair of mounting holes 234 may be formed in the first face 202 adjacent the shaft through-hole 230 to facilitate mounting of a shaft end cap as will be described hereafter.

The first and second housing side plates 200, 200′ may include a work access hole 236 extending there through to facilitate access to attachment features such as bolts extending through a first and second stop arm on the power work device 60 as will be described hereafter. The first and second housing side plates 200, 200′ may each also include a first set of mounting holes 238 extending there through for mounting the angle bracket 244 and may be constructed and arranged to align with mounting holes formed on the angle bracket 244 as discussed hereafter. The mounting holes 238 may be formed along a first line and a second line. The first and second housing side plates 200, 200′ may also include a second set of through-holes 86′ which may extend through the first face 202 and the second face 204 and which may be adjacent the first edge 212. The second set of through-holes 86′, 114′ may be constructed and arranged to align with the first set of through-holes 86, 114 on each of the first and second side plates 68, 96, of the link-lock base assembly 62, for example as illustrated in FIG. 2. The first and second housing side plates 200, 200′ may have a lockout through-hole 242 formed there through for alignment with a lockout hole in a stop arm as described hereafter and through which a rod or a bar may be inserted to lock the work device from movement. A plurality of support mounting holes 240 may be formed through the first and second housing side plates 200, 200′ along each of the third side edge 216 and the fourth side edge 218.

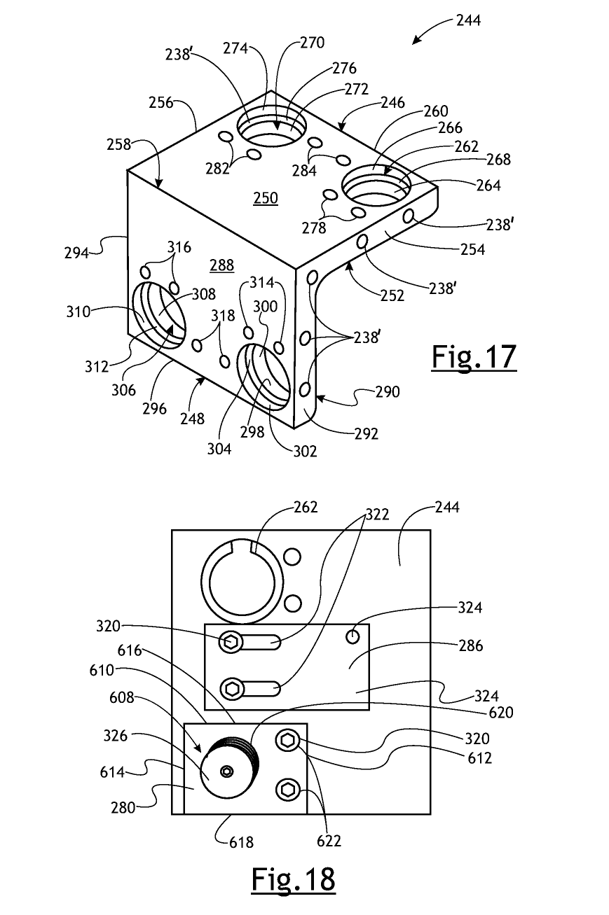

Referring to FIGS. 17-19, in any of a number of variations, an angle bracket 244 may be attached to both the first and second housing side plates 200, 200′. In any of a number of variations, an angle bracket 244 may include a first leg 246 and a second leg 248. The first leg 246 and second leg 248 may be one continuous, non-joined, piece or may be two separate pieces if desired. The first leg 246 may include a first face 250 and an opposite second face 252, a first side 254 and an opposite second side 256, a first edge 258 and second edge 260 each extending between the first side 254 and opposite second side 256. A first through-hole 262 may extend through the first leg 246 from the first face 250 to the second face 252. The first through-hole 262 may be constructed and arranged to receive a portion of a shock absorber 326 there through, for example as illustrated in FIG. 18, and may include a first cylindrical surface 264 extending from the second face 252 and having a first diameter, a second cylindrical surface 266 extending from the first face 250 and having a second diameter, and a lip 268 extending between the first cylindrical surface 264 and second cylindrical surface 266. The diameter of the second cylindrical surface 266 may be greater than the diameter of the first cylindrical surface 264. The first through-hole 262 may be located near the first side 254 and the second edge 260. Similarly, a second through-hole 270 may be provided in the first leg 246 and may include a third cylindrical surface 272 extending from the second face 252 having a first diameter, a fourth cylindrical surface 274 extending from the first face 250 having a second diameter, and a second lip 276 extending there between. The diameter of the fourth cylindrical surface 274 may be greater than the diameter of the third cylindrical surface 272. In a number of variations the second through-hole 270 may be constructed as the mirror image of the first through-hole 262.

A plurality of holes 238′ may be provided along the first side 254 and opposite second side 256. In a number of variations, a first set of mounting holes 278 may be provided in the first leg 246 adjacent the first through-hole 262. The first set of mounting holes 278 may be utilized to mount a shock mounting block 280, having a through-hole formed therein (not illustrated), to the first face 250 of the first leg 246. Similarly, a second set of mounting holes 282 may be positioned adjacent the second through-hole 270 for mounting a shock mounting block 280, having a through-hole formed therein (not illustrated), for receiving a shock absorber 326, for example as illustrated in FIG. 18. A third set of mounting holes 284 may be provided in the first face 250 of the first leg 246 to facilitate mounting any of a variety of accessories to the angle bracket 244 such as, but not limited to, proximity sensors or a mounting plate 286, for example as illustrated in FIG. 18.

The second leg 248 may be similarly constructed as the first leg 246. In a number of variations the second leg 246 may be constructed as the mirror image of the first leg 246. The second leg 248 may include a third face 288 and an opposite fourth face 290, a third side 292 and an opposite fourth side 294, a first edge 258 and an opposite third end edge 296. A third through-hole 298 may be formed in the second leg 248 and may include a fifth cylindrical surface 300 having a first diameter and extending from the fourth face 290, a sixth cylindrical surface 302 having a second diameter and extending from the third face 288, and a third lip 304 extending there between. The diameter of the sixth cylindrical surface 302 may be greater than the diameter of the fifth cylindrical surface 300. A fourth through-hole 306 may be provided in the second leg 248 and may be defined by a seventh cylindrical surface 308 having a first diameter and extending from the fourth face 290, an eighth cylindrical surface 310 having a second diameter and extending from the third face 288, and a fourth lip 312 extending there between. The diameter of the eighth cylindrical surface 310 may be greater in diameter than the seventh cylindrical surface 308. A first, second, and third set of mounting holes 314, 316, 318 may be formed in the third face 288 in a similar fashion to the first, second, and third set of mounting holes 278, 282, 284 formed in the first face 250. In a number of variations the fourth through-hole 306 may be constructed as the mirror image of the third through-hole 298.

The mirrored arrangement of through-holes 262, 270, 298, 306, as well as mounting holes 278, 282, 284, 314, 316, 318 in the first leg 246 and the second leg 248 of the angle bracket 244 may allow for easy installation of the angle bracket 244, and may allow for the repositioning of the shock absorbers 326, 326′ and repositioning of the a stop arm assembly 442 from the right side of the work arm 410 to the left side of the work arm 410 to accommodate working environments and obstacles in the operation of the power work device 60.

In any of a number of variations, the angle bracket 244 may be constructed and arranged so that one or more mounting plate(s) 286 may be attached thereto by one or more mechanical fasteners 320, for example but not limited to, one or more bolts, extending through a slot 322 wherein the mechanical fastener 320 may be received in a mounting hole 284, 318 in the angle bracket 244. One or more through-holes 324 may be provided in the mounting plate 286 for attachment of a number of devices including, but not limited to, displacement or proximity sensors (not illustrated).

Referring to FIGS. 1, 18, 19, and 25, in any of a number of variations, one or more shock mounting block(s) 280, 280′ may be secured to the angle bracket 244, for example, by one or more mechanical fasteners 320 extending through at least one through-hole 262, 270, 298, 306 formed through the shock mounting block 280. A shock mounting block 280, 280′ may include a top face 608, a bottom face 610, a front face 612, a rear face 614, a first side face 616, and a second side face 618. The shock mounting block 280, 280′ may include a shock absorber through-hole 620 which may extend through the top face 608 and the bottom face 610 adjacent the rear face 614. The shock mounting block 280, 280′ may also include at least one through-hole 622 which may extend through the top face 608 and the bottom face 610 and which may be located adjacent the front face 612, and may be constructed and arranged to accommodate a mechanical fastener 320. The shock absorber 326 may have a portion received in the shock absorber through-hole 620 formed in the shock mounting block 280, 280′ and may extend through one of the through-holes 262, 270, 298, 306 formed in the angle bracket 244. In any of a number of variations, a first shock mounting block 280 may be attached to the first face 250 of the first leg 246 of the angle bracket 244 and may be aligned with the first or second through-hole 262, 270 and a second shock mounting block 280′ may be attached to the third face 288 of the second leg 248 of the angle bracket 244, for example as illustrated in FIG. 25.

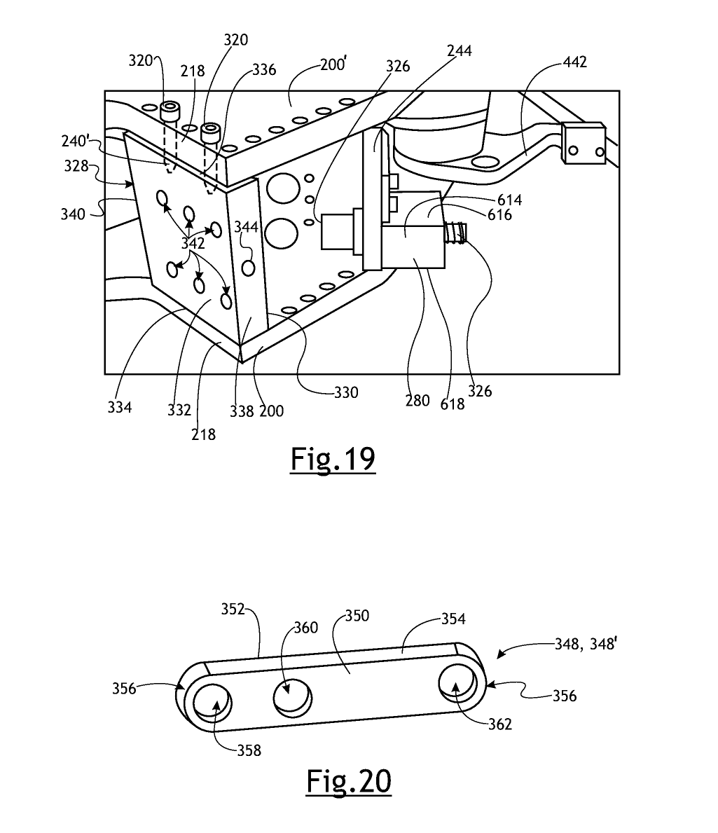

In any of a number of variations, the angle bracket 244 may be attached to the first and second housing side plates 200, 200′ by attaching a mechanical fastener 320 through the first set of mounting holes 238 on each of the first and second housing side plates 200, 200′ and through the mounting holes 238′ located on the first, second, third, and fourth side faces 254, 256, 292, 294 of the angle bracket 244, for example as illustrated in FIGS. 1 and 19.

Referring to FIGS. 1 and 19, in any of a number of variations, a support plate 328 may extend between the first housing side plate 200 and the second housing side plate 200′ adjacent the fourth side edge 218 of each housing side plate 200, 200′. The support plate 328 may include a first face 330, a second face 332, a first side face 334, a second side face 336, a top face 338, and a bottom face 340. The first and second faces 330, 332 may include a plurality of holes 342 which may extend there through. The top face 338 may also include a mounting feature 344 approximately central of the top face 338. The first and second side plates 334, 336 may also include a plurality of mounting features 240′ which may be used to attach the support plate 328 to the first and second housing side plates 200, 200′ by the use of a mechanical fastener 320. One or more mechanical fasteners 320 may extend through the support plate 328 to attach the same to a support pedestal 346, for example as illustrated in FIG. 1.

Referring to FIG. 1, in any of a number of variations, a link-lock working assembly 64 may be attached to the link-lock base assembly 62 and the housing assembly 66. In any of a number of variations, a working assembly 64 may include a third and fourth link-lock plate 348, 348′, a connector 368, an actuator shaft 394, an actuator 396, a first and second stop arm assembly 442, 442′, a work arm assembly 408, and a work arm shaft 470.

Referring to FIG. 20, in any of a number of variations, a third and fourth link-lock plate 348, 348′ may each include a first face 350, a second face 352, and a side face 354. The first and second faces 350, 352 may each include a rounded end 356. A first and third through-hole 358, 362 may be located on each end 356 of the first and second link plates 348, 348′ and may extend through the first face 350 and the second face 352. A second through-hole 360 may be located approximately less than half of the length of the third and fourth link plates 348, 348′ adjacent the first through-hole 358 and may be constructed and arranged to align with a through-hole on a connector which will be discussed hereafter.

Referring to FIGS. 20, 24, and 25, in any of a number of variations, a first link shaft 364 may extend through a through-hole 184 on the first link plate 174, the first through-hole 358 on the third link plate 348 (best illustrated in FIG. 20), an optional spacer 472, the first through-hole 358 located on the fourth link plate 348′ (best illustrated in FIG. 20), and a through-hole 184 on the second link plate 174′, for example as illustrated in FIG. 25, to connect the link-lock base assembly 62 to the link-lock working assembly 64. The first and third link-plates 174, 348, and second and fourth link-plates 348′, 174′ may each form a link-lock assembly 476, 476′, for example as illustrated in FIG. 24.

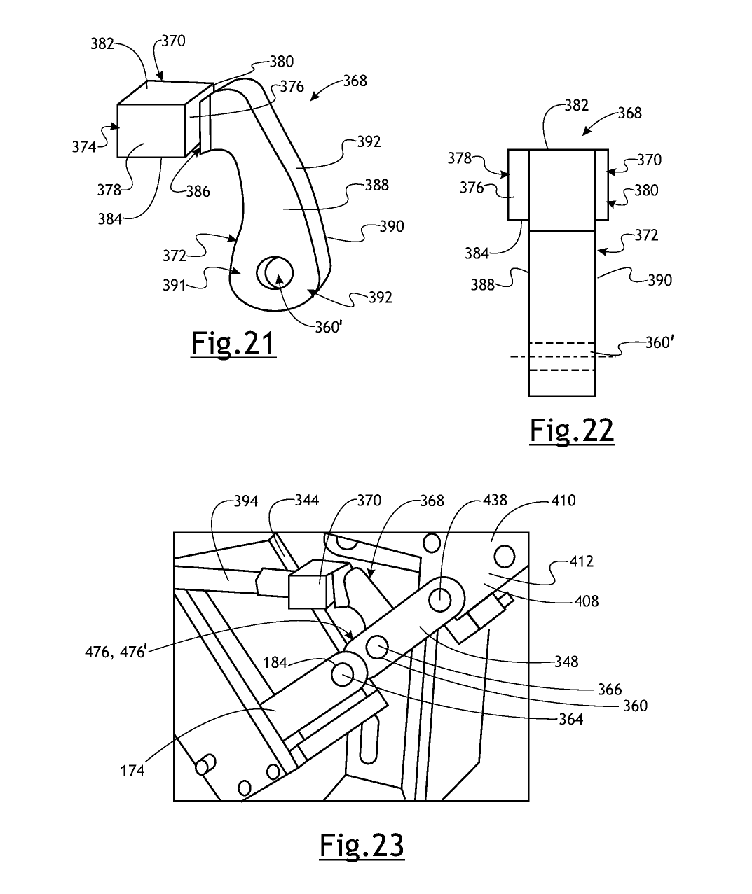

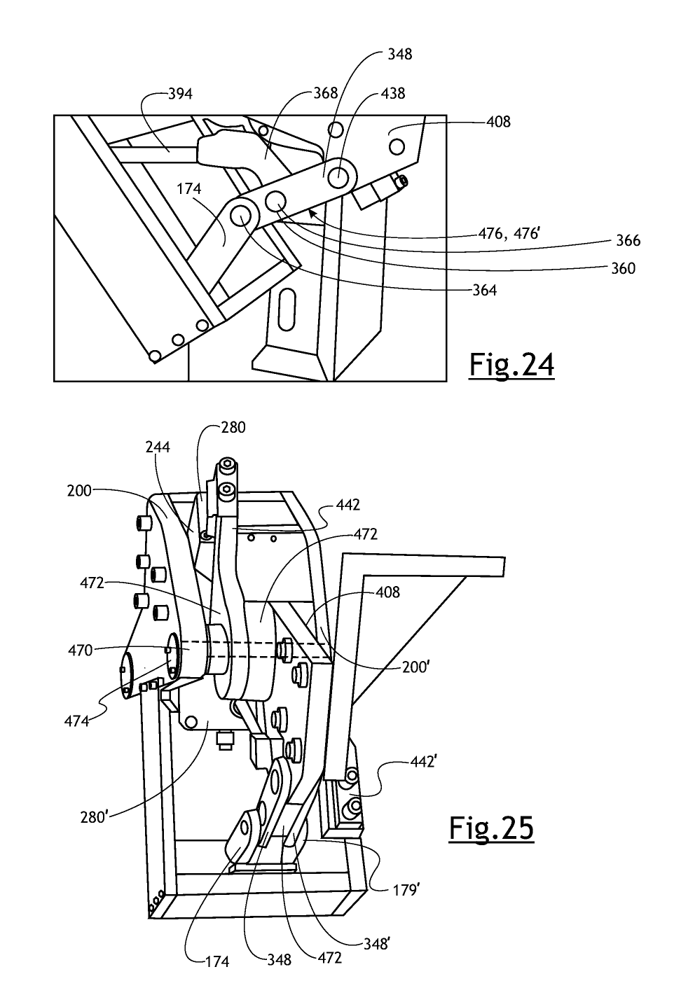

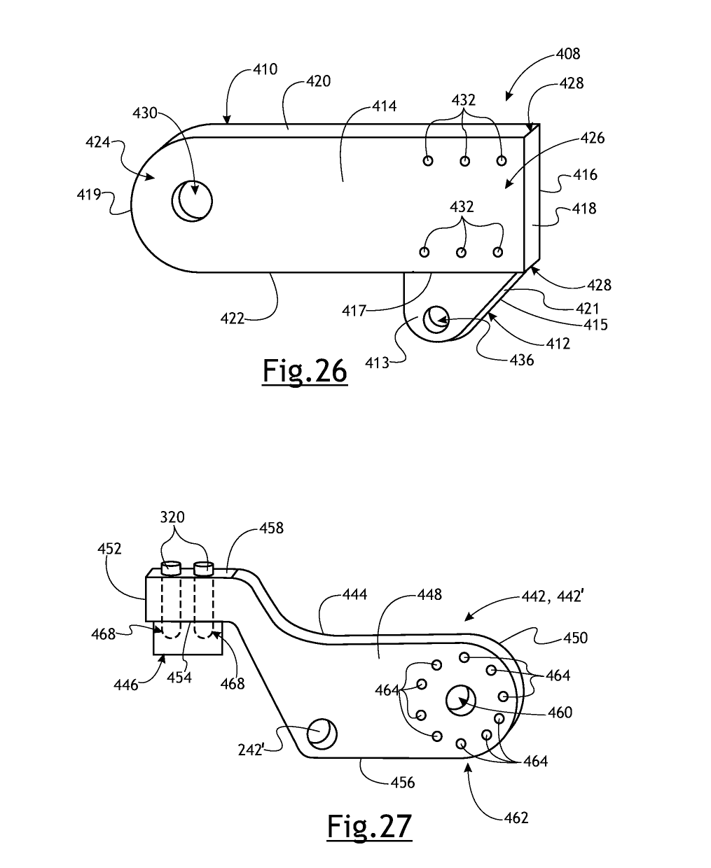

Referring to FIGS. 1 and 21-24, in any of a number of variations, a connector 368 may be attached to the third and fourth link plates 348, 348′. In any of a number of variations, a connector 368 may include a first member 370 and a second member 372. The first member 370 may include a front face 374, a rear face 376, a first side face 378, a second side face 380, a top face 382, and a bottom face 384 and may be any of a number of shapes including, but not limited to, a rectangular box-like shape. In one variation, the second member 372 may include a front face 386, a first side face 388, a second side face 390, and an edge face 392. The first and second faces 388, 390 may increase in width as they extend downward. The bottom portion 391 of the second member 372 may be tear drop-like in shape. The second member 372 may also include a through-hole 360′ which may extend through the first side face 388 and the second side face 390 and which may be constructed and arranged to accommodate a second link shaft as will be described hereafter. The front face 386 of the second member 372 may attach to the rear face 376 of the first member 370. In one variation the first member 370 and the second member 372 may be one single unit, or in another variation the first member 370 and the second member 372 may be two separate components which may be attached in any of a number of variations including, but not limited to, welding. In any of a number of variations, the front face 374 of the first member 370 may be constructed and arranged to attach to an actuator shaft 394, for example as illustrated in FIG. 23. The connector 368 may be attached to the third and fourth link plates 348, 348′ in any of a number of variations including, but not limited to, extending a second link shaft 366 through the second through-hole 360 on the third and fourth link plates 348, 348′ and through the connector 368.

Referring to FIGS. 1, 23, and 31, in any of a number of variations, the front face 374 of the first member 370 of the connector 368 may be attached to an actuator shaft 394. In any of a number of variations, the actuator shaft 394 may be welded, bolted, or threaded into the connector 368, for example as illustrated in FIG. 23. In any of a number of variations the housing assembly 66 may also be attached to the actuator 396 by a pivot rod 228 which may extend through the actuator 396 and the first and second housing side plate 200, 200′ through-holes 222 located adjacent the first corner 206, for example as illustrated in FIG. 1. A pivot rod cap 226 may be attached to each of the first and second housing side plates 200. 200′ by one or more mechanical fasteners 320 extending through the cap 226 and threaded into the pivot rod mounting holes 224 in the first face 202. An actuator 396 may be powered by any of a variety of sources such as electricity, pneumatic, or hydraulic systems. The actuator 396 may include a housing 398. In one variation, an air inlet line 400 may be connected to the housing 398 at a first end 402 and an air outlet line 404 may be connected to the housing 398 at a second end 406, for example as illustrated in FIG. 31. The housing 398 may be constructed and arranged to slidably receive an actuator shaft 394 as discussed hereafter.

Referring to FIGS. 1 and 26, in any of a number of variations, the third and fourth link plates 348, 348′ may be attached to a work arm assembly 408. A work arm assembly 408 may include a work arm 410, and an attachment plate 412, for example as illustrated in FIG. 26. The work arm 410 may include a first side face 414, a second side face 416, a front face 418, a rear face 419, a top face 420, and a bottom face 422. A first end 424 of the work arm 410 may be rounded and a second end 426 may include two edges 428 which may each form 90 degree angles. The first end 424 may include a through-hole 430 which may be constructed and arranged to accept a third link shaft 438 as discussed hereafter. The second end 426 of the work arm 410 may include at least one hole 432 which may be constructed and arranged to accommodate at least one mounting feature including, but not limited to, at least one mechanical fastener which may be used to secure a tool 434, for example as illustrated in FIG. 1, to the work arm 410. Appropriate tools include, but are not limited to, a welding tool or compactor. An attachment plate 412 may also be attached to the bottom face 422 of the second end 426. The attachment plate 412 may include a first face 413, a second face 415, a first edge face 417, and a second edge face 421. The first edge face 417 may be planar and the second edge face 421 may be rounded. The attachment plate 412 may include a through-hole 436 which may extend through the first face 413 and the second face 415 and may be constructed and arranged to accept a third link shaft 438, as will be discussed hereafter. In one variation, the work arm 410 and the attachment plate 412 may be one single unit. In another variation the work arm 410 and the attachment plate 412 may be separate components which may be attached together in any of a variety of ways including, but not limited to, welding.

Referring to FIG. 27, in any of a number of variations, a stop arm assembly 442, 442′ may include a stop arm plate 444 and a shock engagement block 446. The stop arm plate 444 may include a first side face 448, a second side face 450, a front face 452, a first bottom face 454, a second bottom face 456, and a top face 458. A first through-hole 460 may be located at the rear 462 of the stop arm plate 444 and may extend through the first side face 448 and the second side face 450. The first through-hole 460 may be surrounded by a plurality of through-holes 464 which may be positioned at regular intervals so that the stop arm assembly 442, 442′ may be repositioned to change the distance the stop arm plate 444 may travel. For example, the through-holes 464 may be positioned every 15 degrees, 20 degrees, or 30 degrees. The plurality of through-holes 464 may also increase in diameter as they are positioned around the first through-hole 460. A mechanical fastener 320 such as a bolt may extend through one of the stop arm 442, 442′ through holes 464 to releasably fasten the stop arm assembly 442, 442′ to the work arm assembly 408. The position of the stop arm assembly 442, 442′ and thus control of the movement of the work arm assembly 408, may be easily and quickly changed by using the work access holes 236 in the housing side plates 200, 200′ (best illustrated in FIG. 16) to gain access to the mechanical fastener 320. A second through-hole 242′ may be located at the lower middle portion of the stop arm 410 adjacent the second bottom face 456 and may align with a lockout through-hole 242 located in the first housing side plate 200 and the second housing side plate 200′ (best illustrated in FIG. 16). A rod or a bar (not illustrated) may be inserted into the through-holes 242, 242′ to lock the power work device 60 from movement. A shock engagement block 446 may include one or more through-holes 468 which may be constructed and arranged to accommodate one or more mechanical fasteners 320. A shock engagement block 446 may be attached to the first bottom surface 454 of the stop arm plate 444 in any of a variety of ways including, but not limited to, the use of at least one mechanical fastener 320, including, but not limited to a bolt.

Referring to FIG. 25, in any of a number of variations, a first and second stop arm assembly 442, 442′, a work arm assembly 408, and one or more optional spacers 472 may be assembled onto a work arm shaft 470. A first housing side plate 200 and a second housing side plate 200′ may then be attached to either side of the work arm shaft 470 respectively. In any of a number of variations, the stop arm assemblies 442, 442′ may be facing opposite directions and may be aligned with the shock absorbers 326 on the shock mounting blocks 280, 280′. A shaft cap 474 may be provided covering the work arm shaft 470 and mounted to each of the first and second housing side plates 200, 200′ by one or more mechanical fasteners 320 extending through the cap 474 and received in the mounting holes 234 near the second corner 208 of the first and second housing side plates 200, 200′.

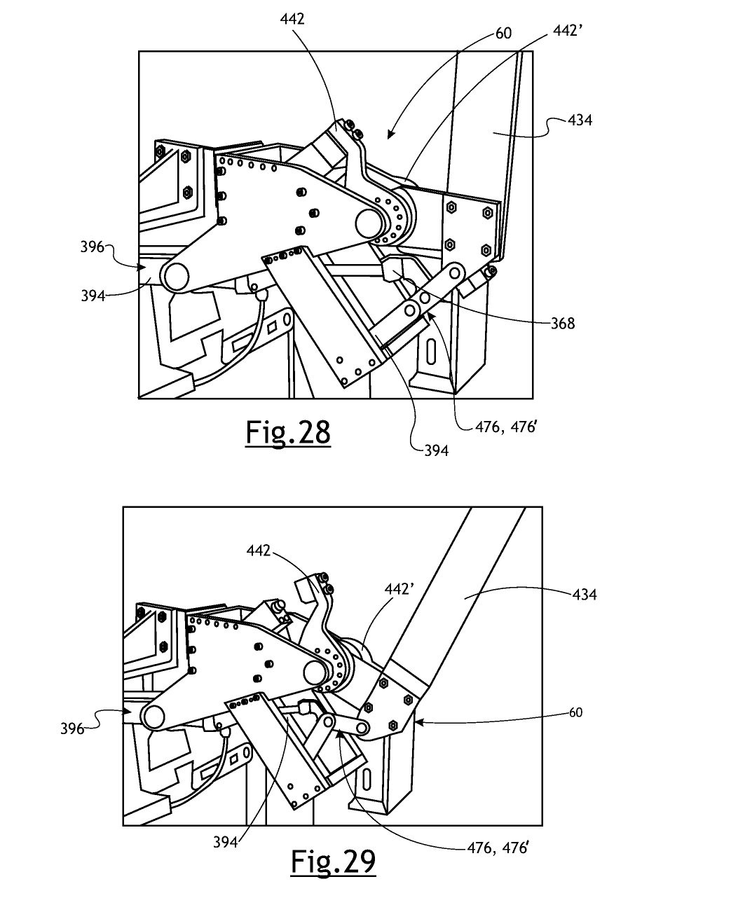

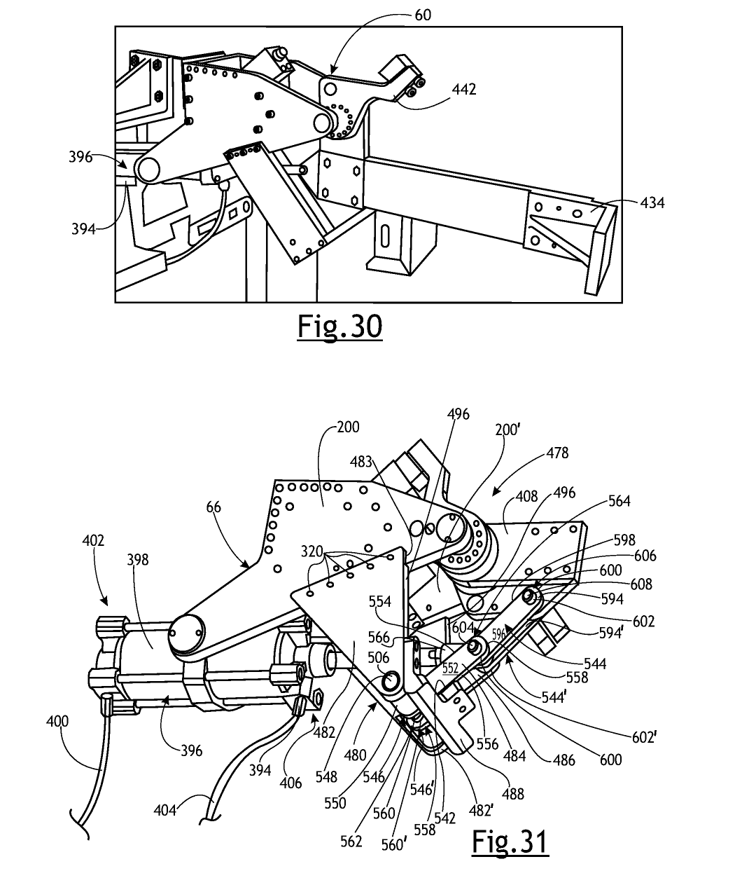

Referring to FIGS. 23-24, and 28-30, in any of a number of variations, an actuator 396 may drive the power work device 60. In a number of variations, the actuator housing 398 may be constructed and arranged to slidably receive the actuator shaft 394. As the actuator housing 398 receives the actuator shaft 394 the connector 368 may be pulled toward the actuator 396 which may cause the link plate assemblies 476, 476′ to retract as illustrated in FIGS. 24, 29, and 30. As the link plate assemblies 476, 476′ are retracting, they may pull the work arm assembly 408 downward which may cause the work arm assembly 408 to rotate from a horizontal position to a vertical position as illustrated in FIGS. 28-30. This may cause a tool 434 which may be attached to the work arm assembly 408 to lower. The first stop arm assembly 442 may be attached to the work arm assembly 408 such that the work arm assembly 408 may cause the first stop arm assembly 442 to rotate backward. The second stop arm 442′ may be attached to the work arm assembly 442′ such that when the work arm is rotated vertically, the second stop arm assembly 442′ may be rotated forward and may cause the shock engagement block 446′ on the second stop arm assembly 442′ to engage a shock absorber 326 which may be mounted on a shock mounting block 280′. The second stop arm assembly 442′ may act as a stop which may prevent over rotation of the work arm assembly 408 and the tool 434. The actuator 396 may then push a portion of the actuator shaft 394 back out of the actuator housing 398 which may push the connector 368 outward which may cause the link assemblies 476, 476′ to straighten out and lock into place. This may cause the work arm assembly 408 to rotate from a vertical position to a horizontal position. This may cause the tool 434 to raise upward, for example as illustrated in FIG. 28. The work arm assembly 408 may also cause the first stop arm assembly 442 shock engagement block 446 to engage with a shock absorber 326 which may be mounted on a shock mounting block 280. The second stop arm 442′ may be attached to the work arm assembly 408 such that when the work arm assembly 408 rotates into a horizontal position, the second stop arm 442′ may be rotated backward. The first stop arm assembly 442 may act as a stop which may prevent over rotation of the work arm assembly 408 and the tool 434.

Referring to FIG. 31, in another variation, a power work device 478 may include a link-lock base assembly 480 which may be constructed and arranged so that the actuator 396 may attach directly to the link-lock assemblies 544, 544′. In any of a number of variations, a link-lock base assembly 480 may include a first and second side plate 482, 482′, a first link plate 484, a second link plate 486, and a support bracket 488.

Referring to FIGS. 16 and 31-32, in any of a number of variations, a first and second side plate 482, 482′ may be triangular in shape and may include a first face 490, a second face 492, a first edge 494, a second edge 496, a third edge 498, a first corner 500, a second corner 502, and third corner 504. The second side plate 482′ may be the mirror image of the first side plate 482. The second face 492 of the first and second side plates 482, 482′ may include an indentation or cutout 483 which may be constructed and arranged to mate with a first and second housing side plate 200, 200′ respectively, for example as illustrated in FIG. 31. A through-hole 506 may be located adjacent the first corner 500 and may be constructed and arrange to accommodate a link-lock base assembly shaft as discussed hereafter. A plurality of through-holes 510 may extend through the first and second faces 490, 492 and may be located adjacent the first edge 494. The plurality of through-holes 510 may lie on the same linear plane. The plurality of through-holes 510 may be constructed and arranged to align with the first set of through-holes 86 located on the first and second housing side plates 200, 200′, as for example as illustrated in FIG. 16. The first and second side plates 482, 482′ may also include a pair of mounting holes 514 which may be constructed and arranged to align with a pair of mounting holes 514′ located on a support bracket 512, for example as illustrate in FIG. 31. The first and second side plates 482, 482′ may then be attached to the housing assembly 66 in any of a variety of ways including, but not limited to, placing at least one mechanical fastener 320 into the plurality of through-holes 510 on the first and second side plates 482, 482′ as well as the through-holes 86′ on the first and second housing side plates 200, 200′, for example as illustrated in FIG. 31.

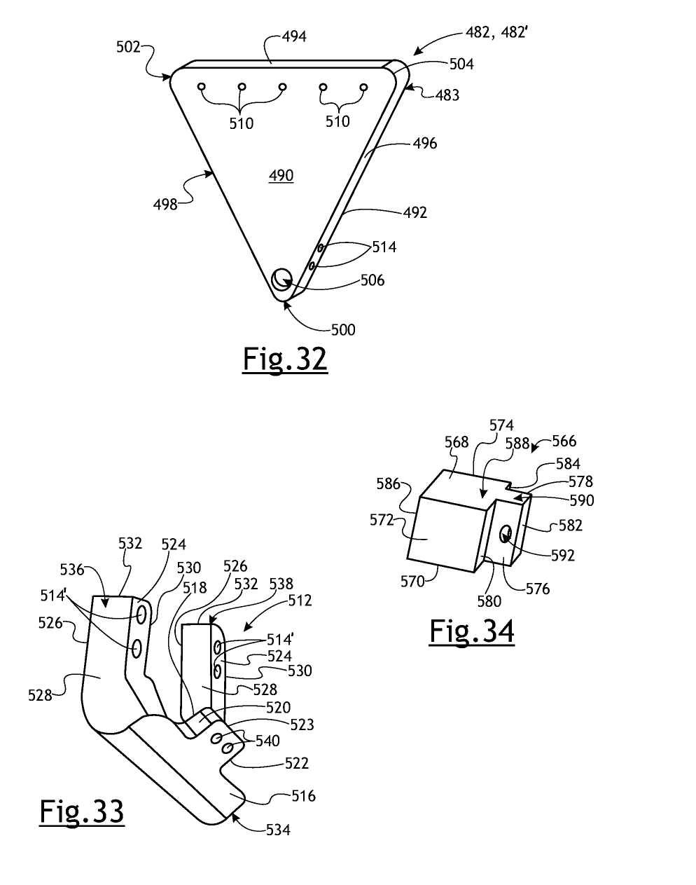

Referring to FIGS. 31-33, in any of a number of variations, a support bracket 512 may be attached to the second edge 496 of the first and second side plates 482, 482′. In any of a number of variations, a support bracket 512 may include a bottom structure 534 and a first and second arm structure 536, 538, for example as illustrated in FIG. 33. The bottom structure 534 may include a bottom face 516, a top face 518, a first side face 520, a second side face 522, and a front face 523. The bottom structure 534 may include a set of through-holes 540 which may be constructed and arranged to align with the set of mounting holes 540 on an engagement plate 542 as discussed hereafter. The first and second arm structures 536, 538 may each include a front face 524, a rear face 526, a first side face 528, a second side face 530, and a top face 532. The first and second arms 536, 538 may each include a set of through-holes 514′ which may be constructed and arranged to align with the mounting holes 514 located on the second edge 496 of the first and second side plates 482, 482′, for example as illustrated in FIG. 32. The first and second arm structures 536, 538 may extend upward at an acute angle from the bottom structure 534.

The support bracket 512 may be attached to the first and second side plates 482, 482′ in any of a number of variations including, but not limited to, attaching at least one mechanical fastener through at least one of the through-holes 514′ located on each of the first and second arm structures 536, 538 of the support bracket 512 and into at least one of the mounting holes 514 located on the second edge 496 of each of the first and second side plates 482, 482′, for example as illustrated in FIG. 31.

Referring to FIG. 36, in any of a number of variations, an engagement plate 542 may be attached to the top face 518 of the bottom structure 534 of the support bracket 512 including, but not limited to, a mechanical fastener 320. The engagement plate 542 may absorb some of the impact created by the movement of the link-lock assemblies 544, 544′ and may prevent over rotation of the link-lock assemblies 544, 544′ as discussed hereafter.

Referring to FIG. 31, in any of a number of variations, a first end 562 of each of a first and second link plate 546, 546′ may be attached to the first and second side plates 482, 482′. In any of a number of variations, the first and second link plates 546, 546′ may include a first face 552, a second face 554, and a side face 556. The first and second faces 552, 554 may each include a rounded end 558. A first and second through-hole 560, 560′ may be located on each end 558 of the first and second link plates 546, 546′ and may extend through the first face 552 and the second face 554. The first and second through-holes 560, 560′ may be constructed and arranged to accommodate a shaft 548 as discussed hereafter. In one variation, the first and second through-holes 560, 560′ may be of the type discussed above and may include a first and second cylindrical surface each having a diameter and wherein the second cylindrical surface diameter is greater than the first cylindrical surface diameter. The first and second link plates 546, 546′ may be attached to the first and second side plates 482, 482′ in any of a number of variations including, but not limited to, a link plate shaft 548 which may extend through a through-hole 506 located adjacent the first corner 500 of each of the first and second side plates 482, 482′, a first through-hole 560 on the first and second link plates 546, 546′, and one or more optional spacers 550.

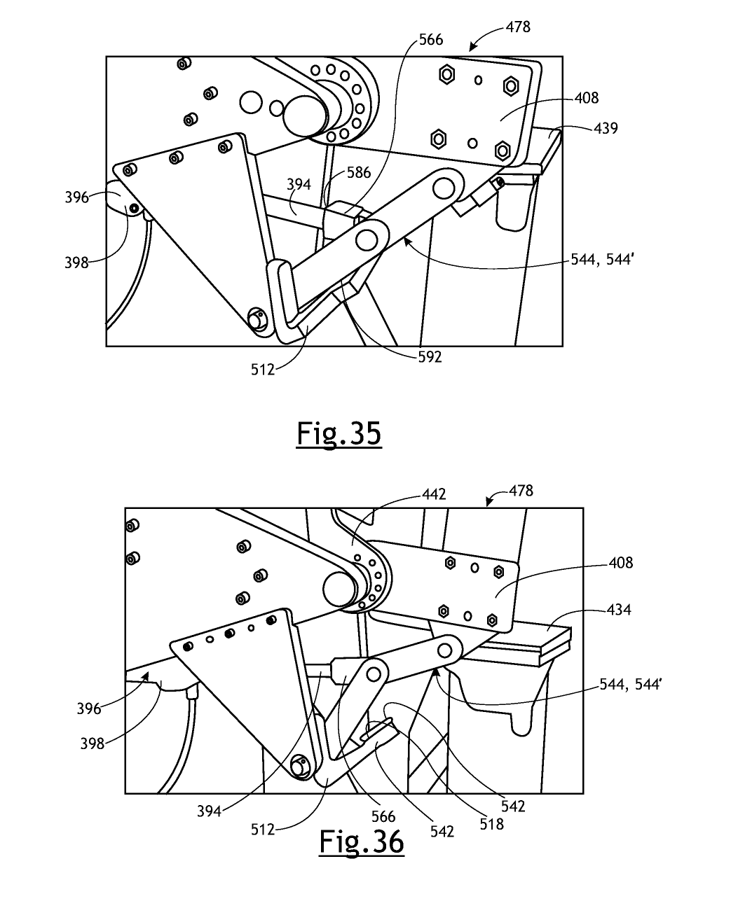

Referring to FIGS. 34 and 35 in any of a number of variations, an actuator connector 566 may include a top face 568, bottom face 570, a first side face 572, a second side face 574, a third side face 576, a fourth side face 578, a first, second, and third front face 580, 582, 584, and a rear face 586. The top and bottom faces 568, 570 may comprise a first rectangular or square-like portion 588 and a second rectangular portion 590 which may have a smaller width that then first rectangular portion 588. The third and fourth side faces 576, 578 may include a through-hole 592 which may be constructed and arranged to accommodate a shaft as discussed hereafter. The rear face 586 may be constructed and arranged to mate with an actuator shaft 394, for example as illustrated in FIG. 35. The rear face 586 may be attached to the actuator shaft 394 in any of a number of variations including, but not limited to, a cavity which may be constructed and arranged to accommodate an actuator shaft 394.

Referring to FIG. 31, in any of a number of variations, a third and fourth link plate 594, 594′ may each include a first face 596 and a second face 598. The first and second faces 596, 598 may each include a rounded end 600. A first and second through-hole 602, 602′ may be located on each end 600 of the first and second link plates 594, 594′ and may extend through the first face 596 and the second face 598. In one variation the through-holes 602, 602′ may be of the type discussed above wherein each through-hole 602, 602′ include a first and second cylindrical surface each having a diameter and wherein the second cylindrical surface diameter is greater than the first cylindrical surface diameter The first and second through-holes 602, 602′ may be constructed and arranged to each accommodate a shaft as discussed hereafter.

Referring again to FIG. 31, in any of a number of variations, a second end 564 of the first and second link plates 482, 482′ may be attached to an actuator connector 566, and a third and fourth link plate 594, 594′. In one variation, a link shaft 604 may extend through the first link plate 546, the third link plate 594, the actuator connector 566, the second link plate 546′, the fourth link plate 594′, and any optional spacers. The second end 606 of the third and fourth link plates 594, 594′ may be attached to the link-lock work assembly 62 via a shaft 608 through the second through-hole 602, in the same manner as the variation discussed above.

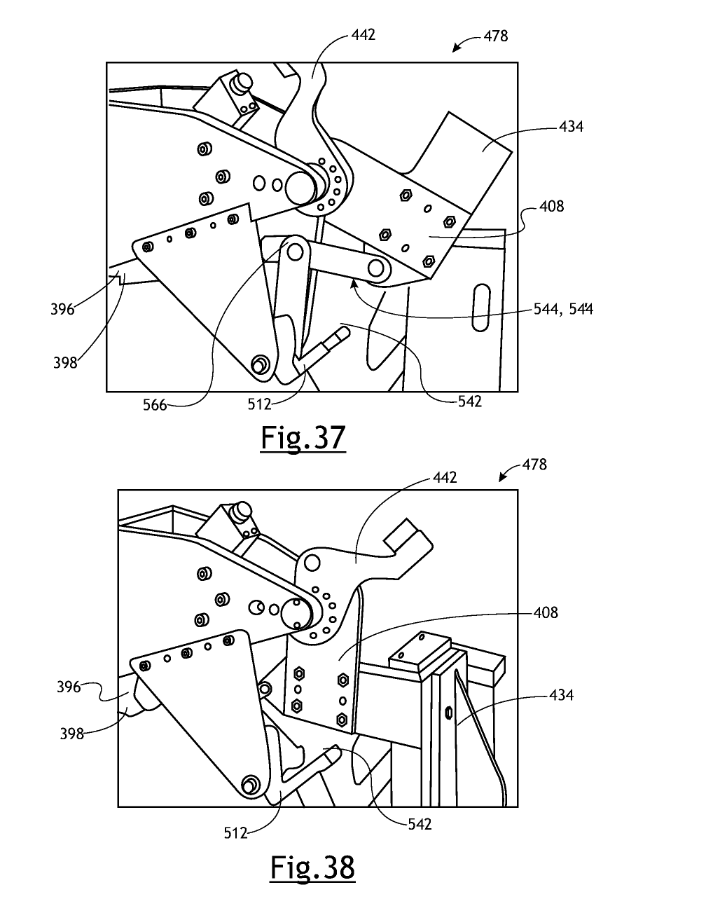

Referring to FIGS. 35-38, in any of a number of variations, the actuator 396 may drive the power work device 478. In a number of variations, the housing 398 may be constructed and arranged to slidably receive the actuator shaft 394. As the actuator housing 398 receives the actuator shaft 394 the actuator connector 566 may be pulled toward the actuator 396 which may cause the link plate assemblies 544, 544′ to retract which may pull the work arm assembly 408 downward which may cause the work arm assembly 408 to rotate from a horizontal position to a vertical position, for example as illustrated in FIGS. 37-38. This may cause the work arm assembly 408 to lower a tool 434 which may be attached to the work arm assembly 408. A first and second stop arm 442, 442′ may be attached to the work arm assembly 408 in the same manner as the variation discussed above. The first stop arm assembly 442 may be attached to the work arm assembly 408 such that when the work arm is rotated vertically, the first stop arm assembly 442 may be rotated backward. A second stop arm assembly 442′ may be attached to the work arm assembly 442′ such that when the work arm assembly 408 is rotated vertically, the second stop arm assembly 442′ may be rotated forward and may cause the shock engagement block 446′ on the second stop arm assembly 442′ to engage with a shock absorber 326. The second stop arm assembly 442′ may act as a stop which may prevent over rotation of the work arm assembly 408 and the tool 434. The actuator 396 may then push a portion of the actuator shaft 394 back out of the actuator housing 398 which may push the connector 368 outward which may cause the link assemblies 476, 476′ to straighten out and lock into place, for example as illustrated in FIG. 35. This may cause the work arm assembly 408 to rotate from a vertical position to a horizontal position. This may cause the tool 434 to rise upward. As discussed in the variation above, the work arm assembly 408 may also cause the first stop arm assembly 442 to rotate forward which may cause the shock engagement block 446 on the first stop arm assembly 442 to engage with the shock absorber 326. The second stop arm assembly 442′ may be attached to the work arm assembly 408 such that when the work arm assembly 408 rotates into a horizontal position, the second stop arm 442′ may be rotated backward. The first stop arm assembly 442 may act as a stop which may prevent over rotation of the work arm assembly 408 and the tool 434. The link-lock assemblies 544, 544′ may also engage with an engagement plate 542 located on the support bracket 512, which may absorb some of the impact which may be created by the movement of the link-lock assemblies 544, 544′ and may prevent over rotation of the link-lock assemblies 544, 544′.

The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may include a product comprising: a link-lock base assembly constructed and arranged for use in a link-lock power work device, the link-lock base assembly comprising: a first side plate; a second side plate; a base plate extending between the first side plate and the second side; a first spacer block attached to the base plate adjacent the first side plate; a second spacer block attached to the base plate adjacent the second side plate; a first link plate and a second link plate; wherein a first end of the first link plate is adjacent the first spacer; wherein and a first end of the second link plate is adjacent the second spacer; a third spacer block attached to the base plate in between the first end of the first link plate and the first end of the second link plate; and a first shaft which extends through the first side plate, the first end of the first link plate, the third spacer block, the first end of the second link plate, the second spacer block, and the second side plate.

Variation 2 may include the product of claim 1 further comprising a link-lock power work device comprising: a third link plate and a fourth link plate each having a first end and a second end; a second shaft which extends through the second end of the first link plate, the first end of the third link plate, the second end of the second link plate, and the first end of the fourth link plate; a connector; a third shaft which extends through the third link plate between the first and the second ends, the connector, and the fourth link plate between the first and the second ends; a first housing side plate and a second housing side plate; wherein the link-lock base assembly first side plate is attached to the first housing side plate and the link-lock base assembly second side plate is attached to the second housing side plate; a housing support plate which extends between the first housing side plate and the second housing side plate; an angle bracket which extends between the first housing side plate and the second housing side plate and wherein the angle bracket includes a first leg and a second leg; a first shock mounting block and a second shock mounting block; wherein the first shock mounting block is attached to the first leg of the angle bracket and the second shock mounting block is attached to the second leg of the angle bracket; a first and second shock absorber; wherein the first shock absorber extends through the first leg of the angle bracket and the first shock mounting block and the second shock absorber extends through the second leg of the angle bracket and the second shock mounting block; a work arm assembly having a first end and a second end; wherein the first end of the work arm assembly is constructed and arranged to attach to a tool; a fourth shaft which extends through the second end of the third link plate, the second end of the work arm assembly, and the second end of the fourth link plate; a first and second stop arm having a first end and a second end; a first and second engagement block attached to the first and second shock absorbers respectively; wherein the first stop arm attaches to a first side face of the work arm assembly and the second stop arm attaches to a second side face of the work arm assembly; a fifth shaft which extends through the first housing side plate, the second end of the first stop arm, the second end of the work arm assembly, the second end of the second stop arm, and the second housing side plate; an actuator; an actuator shaft attached to the actuator and the connector; and wherein a pivot rod extends through the first housing side plate, the actuator, and the second housing side plate.

Variation 3 may include a product as set forth in any of Variations 1-2 wherein the first stop arm and the second stop arm are attached to the work arm assembly facing opposite directions and are constructed and arranged to align with the first shock absorber and the second shock absorber respectively; wherein each of the first stop arm and second stop arm have a plurality of mounting holes formed there through at regular intervals, at least a first fastener extending through one of the mounting holes in the first stop arm and attaching the first stop arm to the work arm, and at least a second fastener extending through one of the mounting holes in the second stop arm and attaching the second stop arm to the work arm assembly; and wherein the first housing side plate includes a first work access hole formed there through to provide access to the first fastener and the second housing side plate includes a second work access hole formed there through to provide access to the second fastener.

Variation 4 may include a product as set forth in any of Variations 1-3 wherein a lockout through hole extends through each of the first and the second housing side plates and the first and the second stop arms and are constructed and arranged to accommodate a rod or a bar to prevent movement of the link-lock power work device.

Variation 5 may include a product as set forth in any of Variations 1-4 wherein the actuator includes an actuator housing, and wherein the actuator housing receives and projects the actuator shaft which drives the link-lock power work device to rotate the work arm assembly to either a vertical or horizontal position.

Variation 6 may include a product as set forth in any of Variations 1-5 wherein the first link plate and the second link plate each include a first and a second through-hole; wherein the first through-hole is located on the first end and the second through-hole is located on the second end; wherein the first and second through-hole each include a first cylindrical surface, a second cylindrical surface, and a lip; wherein the first cylindrical surface includes a first diameter and the second cylindrical surface includes a second diameter; and wherein the first diameter is greater than the second diameter.

Variation 7 may include a product as set forth in any of Variations 1-6 wherein first side plate and the second side plate each include a first front face, a second front face, a rear face, a bottom face, a first top face, a second top face, a first side face, and a second side face; wherein the first top face and the second top face of the first side plate angle downward so that the first side face is greater in length than the second side face; wherein a lip extends between the first front face and the second front face of the first side plate; wherein a shaft though-hole extends through the first face and the second face of the first side plate and is adjacent the first side face and the bottom face of the first side plate; wherein the first top face and the second top face of the second side plate angle downward so that the second side face is greater in length than the first side face; wherein a lip extends between the first front face and the second front face of the second side plate; and wherein a shaft through-hole is located adjacent the first side face and the bottom face of the first side plate.

Variation 8 may include a product comprising: a link lock base assembly constructed and arranged for use in a link-lock power work device, the link-lock base assembly comprising: a first side plate and a second side plate; a first spacer located adjacent the first side plate and a second spacer located adjacent the second side plate; a first link plate and a second link plate each having a first end and a second end; wherein the first end of the first link plate is adjacent the first spacer and the first end of the second link plate is adjacent the second spacer; wherein a first shaft extends through the first side plate, the first spacer, the first end of the first link plate, the first end of the second link plate, the second spacer, and the second side plate; and a support bracket which is attached to the first side plate and the second side plate.

Variation 9 may include a product as set forth in Variation 8 wherein the support bracket includes an engagement plate which is constructed and arranged to accommodate a side edge of the first link plate and a side edge of the second link plate.

Variation 10 may include a product as set forth in any of Variations 8-9 further comprising link-lock power work device comprising: a third link plate and a fourth link plate each having a first end and a second end; an actuator connector; a second shaft which extends through the second end of the first link plate, the second end of the third link plate, the actuator connector, the first end of the fourth link plate, and the second end of the second link plate; a work arm assembly having a first end and a second end, wherein the first end is constructed and arranged to accommodate a tool; a third shaft which extends through the second end of the third link plate, the second end of the work arm assembly, and the second end of the fourth link plate; a first and second stop arm each having a first end and a second end; wherein the first end of each of the first and the second stop arms are constructed and arranged to attach to a shock engagement block; a first and second engagement block which are constructed and arranged to engage the first and second shock absorbers respectively; wherein the first stop arm attaches to a first side face of the work arm assembly and the second stop arm attaches to a second side face of the work arm assembly; a first housing side plate and a second housing side plate; wherein a fourth shaft extends through the first housing side plate, the second end of the first stop arm, the second end of the work arm assembly, the second end of the second stop arm assembly, and the second housing side plate; wherein the link-lock base assembly first side plate is attached to the first housing side plate and the link-lock base assembly second side plate is attached to the second housing side plate; an actuator; an actuator shaft attached to the actuator and the connector; wherein a pivot rod extends through the first housing side plate, the actuator, and the second housing side plate; an angle bracket having a first leg and a second leg; wherein the angle bracket extends between the first housing side plate and the second housing side plate; a first shock mounting block and a second shock mounting block; wherein the first shock mounting block is attached to the first leg of the angle bracket and the second shock mounting block is attached to the second leg of the angle bracket; a first and second shock absorber; and wherein the first shock absorber extends through the first leg of the first angle bracket and the first shock mounting block and the second shock absorber extends through the second leg of the angle bracket and the second shock mounting block.

Variation 11 may include a product as set forth in any of Variations 8-10 wherein a lockout through hole extends through each of the first and the second housing side plates and the first and the second stop arms are each constructed and arranged to accommodate a rod or a bar to prevent movement of the link-lock power work device.

Variation 12 may include a product as set forth in any of Variations 8-11 wherein the first stop arm and the second stop arm are attached to the work arm assembly in opposite directions and are constructed and arranged to align with the first shock absorber and the second shock absorber; wherein each of the first stop arm and second stop arm have a plurality of mounting holes formed there through at regular intervals, at least a first fastener extending through one of the mounting holes in the first stop arm and attaching the first stop arm to the work arm, and at least a second fastener extending through one of the mounting holes in the second stop arm and attaching the second stop arm to the work arm; and wherein the first housing side plate includes a first work access hole formed there through to provide access to the first fastener and the second housing side plate includes a second work access hole formed there through to provide access to the second fastener.

Variation 13 may include a product as set forth in any of Variations 8-12 wherein the actuator includes an actuator housing, and wherein the actuator housing receives and projects the actuator shaft which drives the link-lock power work device to rotate the work arm assembly to either a vertical or horizontal position.

Variation 14 may include a product as set forth in any of Variations 8-13 wherein the support bracket includes a bottom structure, and a first and a second arm structure; wherein the bottom structure includes a bottom face, a top face, a first side face, a second side face, and a front face; wherein the first and the second arm structures each include a front face, a rear face, a first side face, a second side face, and a top face; wherein the first and the second arm structures extend upward at an acute angle from the bottom structure; and wherein an engagement plate is attached to the top surface of the bottom structure and is constructed and arranged to accommodate a side edge of the first link plate and a side edge of the second link plate.

Variation 15 may include a product as set forth in any of Variations 8-14 wherein the first side plate and the second side plate are triangular in shape and each include a cutout adjacent the first edge which is constructed and arranged to mate with a housing side plate.

Variation 16 may include a method comprising: providing a link-lock power work device; wherein an actuator drives a link-lock power work arm assembly in the link-lock power work device by protruding and retracting an actuator shaft which straightens and retracts causing the work arm assembly to rotate in a horizontal or vertical position; and wherein a first stop arm engages a first shock absorber when the work arm assembly is in a horizontal position and wherein a second stop arm engages a second shock absorber when the work arm is in a vertical position.

Variation 17 may include a method as set forth in Variation 16 wherein each of the first stop arm and second stop arm have a plurality of mounting holes formed there through at regular intervals so that the stop arms can be set at different positions.

Variation 18 may include a method as set forth in any of Variations 16-17 wherein the link-lock power work device includes a lockout feature which prevents the link-lock power work device from operating.

Variation 19 may include a method as set forth in any of Variations 16-18 wherein a tool is attached to the link-lock power work device work arm assembly and wherein the tool is in a raised position when the work arm assembly is in a vertical position and the tool is in a lowered position when the work arm assembly is in a horizontal position.

Variation 20 may include a product comprising a housing side plate for use in a power work device having a first corner, a second corner, and a third corner; wherein the first corner is rounded, the second corner is rounded, and the third corner forms an angle; wherein a first side edge extends from the first corner to the second corner, and a second side edge extends from the second corner to a third side edge; wherein the second side edge and third side edge form an obtuse angle; wherein a fourth side edge extends from the third corner and engages a fifth side edge which extends from the first corner; wherein a pivot rod through-hole is formed adjacent the first corner; wherein a first pair of mounting through-holes are formed in a first face of the housing side plate adjacent the pivot rod through-hole; wherein a shaft through-hole is formed in the housing side plate adjacent the second corner; wherein a second pair of mounting through-holes is formed in the first face adjacent the shaft through-hole; wherein a work access through-hole extends through the housing side plate adjacent the shaft through-hole; wherein a first set of mounting through-holes is located near a center of the housing side plate and which are constructed and arranged for mounting an angle bracket; wherein a second set of mounting through-holes are located adjacent the first side edge and which are constructed and arranged for mounting a link-lock base assembly side plate; wherein a third set of mounting through-holes is located adjacent the fourth and fifth side edges and which are constructed and arrange to mount a support plate; and wherein a lockout through-hole is located adjacent the work access through-hole.

The above description of select variations within the scope of the invention is merely illustrative in nature and, thus, variations or variants thereof are not to be regarded as a departure from the spirit and scope of the invention.

What is claimed is:

1. A product comprising:
a link-lock base assembly constructed and arranged for use in a link-lock power work device, the link-lock base assembly comprising:
a first side plate;
a second side plate;
a base plate extending between the first side plate and the second side;
a first spacer block attached to the base plate adjacent the first side plate;
a second spacer block attached to the base plate adjacent the second side plate;
a first link plate and a second link plate;
wherein a first end of the first link plate is adjacent the first spacer;
wherein and a first end of the second link plate is adjacent the second spacer;
a third spacer block attached to the base plate in between the first end of the first link plate and the first end of the second link plate; and
a first shaft which extends through the first side plate, the first end of the first link plate, the third spacer block, the first end of the second link plate, the second spacer block, and the second side plate.

2. The product of claim 1 further comprising a link-lock power work device comprising:
a third link plate and a fourth link plate each having a first end and a second end;
a second shaft which extends through the second end of the first link plate, the first end of the third link plate, the second end of the second link plate, and the first end of the fourth link plate;
a connector;
a third shaft which extends through the third link plate between the first and the second ends, the connector, and the fourth link plate between the first and the second ends;
a first housing side plate and a second housing side plate;
wherein the link-lock base assembly first side plate is attached to the first housing side plate and the link-lock assembly second side plate is attached to the second housing side plate;
a housing support plate which extends between the first housing side plate and the second housing side plate;
an angle bracket which extends between the first housing side plate and the second housing side plate and wherein the angle bracket includes a first leg and a second leg;
a first shock mounting block and a second shock mounting block;
wherein the first shock mounting block is attached to the first leg of the angle bracket and the second shock mounting block is attached to the second leg of the angle bracket;
a first and second shock absorber;
wherein the first shock absorber extends through the first leg of the angle bracket and the first shock mounting block and the second shock absorber extends through the second leg of the angle bracket and the second shock mounting block;
a work arm assembly having a first end and a second end;
wherein the first end of the work arm assembly is constructed and arranged to attach to a tool;
a fourth shaft which extends through the second end of the third link plate, the second end of the work arm assembly, and the second end of the fourth link plate;
a first and second stop arm having a first end and a second end;
a first and second engagement block attached to the first and second shock absorbers respectively;
wherein the first stop arm attaches to a first side face of the work arm assembly and the second stop arm attaches to a second side face of the work arm assembly;
a fifth shaft which extends through the first housing side plate, the second end of the first stop arm, the second end of the work arm assembly, the second end of the second stop arm, and the second housing side plate;
an actuator;
an actuator shaft attached to the actuator and the connector; and
wherein a pivot rod extends through the first housing side plate, the actuator, and the second housing side plate.

3. The product of claim 2 wherein the first stop arm and the second stop arm are attached to the work arm assembly facing opposite directions and are constructed and arranged to align with the first shock absorber and the second shock absorber respectively;
wherein each of the first stop arm and second stop arm have a plurality of mounting holes formed there through at regular intervals, at least a first fastener extending through one of the mounting holes in the first stop arm and attaching the first stop arm to the work arm, and at least a second fastener extending through one of the mounting holes in the second stop arm and attaching the second stop arm to the work arm assembly; and
wherein the first housing side plate includes a first work access hole formed there through to provide access to the first fastener and the second housing side plate includes a second work access hole formed there through to provide access to the second fastener.

4. The product of claim 2 wherein a lockout through hole extends through each of the first and the second housing side plates and the first and the second stop arms and are constructed and arranged to accommodate a rod or a bar to prevent movement of the link-lock power work device.

5. The product of claim 2 wherein the actuator includes an actuator housing, and wherein the actuator housing receives and projects the actuator shaft which drives the link-lock power work device to rotate the work arm assembly to either a vertical or horizontal position.

6. The product of claim 1 wherein the first link plate and the second link plate each include a first and a second through-hole;
wherein the first through-hole is located on the first end and the second through-hole is located on the second end;
wherein the first and second through-hole each include a first cylindrical surface, a second cylindrical surface, and a lip;
wherein the first cylindrical surface includes a first diameter and the second cylindrical surface includes a second diameter; and
wherein the first diameter is greater than the second diameter.

7. The product of claim 1 wherein first side plate and the second side plate each include a first front face, a second front face, a rear face, a bottom face, a first top face, a second top face, a first side face, and a second side face;
wherein the first top face and the second top face of the first side plate angle downward so that the first side face is greater in length than the second side face;
wherein a lip extends between the first front face and the second front face of the first side plate;
wherein a shaft though-hole extends through the first face and the second face of the first side plate and is adjacent the first side face and the bottom face of the first side plate;
wherein the first top face and the second top face of the second side plate angle downward so that the second side face is greater in length than the first side face;
wherein a lip extends between the first front face and the second front face of the second side plate; and
wherein a shaft through-hole is located adjacent the first side face and the bottom face of the first side plate.

8. A product comprising:
a link lock base assembly constructed and arranged for use in a link-lock power work device, the link-lock base assembly comprising:
a first side plate and a second side plate;
a first spacer located adjacent the first side plate and a second spacer located adjacent the second side plate;
a first link plate and a second link plate each having a first end and a second end;
wherein the first end of the first link plate is adjacent the first spacer and the first end of the second link plate is adjacent the second spacer;
wherein a first shaft extends through the first side plate, the first spacer, the first end of the first link plate, the first end of the second link plate, the second spacer, and the second side plate; and
a support bracket which is attached to the first side plate and the second side plate.

9. The product of claim 8 wherein the support bracket includes an engagement plate which is constructed and arranged to accommodate a side edge of the first link plate and a side edge of the second link plate.

10. The product of claim 8 further comprising link-lock power work device comprising:
a third link plate and a fourth link plate each having a first end and a second end;
an actuator connector;
a second shaft which extends through the second end of the first link plate, the second end of the third link plate, the actuator connector, the first end of the fourth link plate, and the second end of the second link plate;
a work arm assembly having a first end and a second end, wherein the first end is constructed and arranged to accommodate a tool;
a third shaft which extends through the second end of the third link plate, the second end of the work arm assembly, and the second end of the fourth link plate;
a first and second stop arm each having a first end and a second end;
wherein the first end of each of the first and the second stop arm is constructed and arranged to attach to a shock engagement block;
a first and second engagement block which are constructed and arranged to engage the first and second shock absorbers respectively;
wherein the first stop arm attaches to a first side face of the work arm assembly and the second stop arm attaches to a second side face of the work arm assembly;
a first housing side plate and a second housing side plate;
wherein a fourth shaft extends through the first housing side plate, the second end of the first stop arm, the second end of the work arm assembly, the second end of the second stop arm assembly, and the second housing side plate;
wherein the link-lock base assembly first side plate is attached to the first housing side plate and the link-lock base assembly second side plate is attached to the second housing side plate;
an actuator;
an actuator shaft attached to the actuator and the connector;
wherein a pivot rod extends through the first housing side plate, the actuator, and the second housing side plate;
an angle bracket having a first leg and a second leg;
wherein the angle bracket extends between the first housing side plate and the second housing side plate;
a first shock mounting block and a second shock mounting block;
wherein the first shock mounting block is attached to the first leg of the angle bracket and the second shock mounting block is attached to the second leg of the angle bracket;
a first and second shock absorber; and
wherein the first shock absorber extends through the first leg of the first angle bracket and the first shock mounting block and the second shock absorber extends through the second leg of the angle bracket and the second shock mounting block.

11. The product of claim 10 wherein a lockout through hole extends through each of the first and the second housing side plates and the first and the second stop arms are each constructed and arranged to accommodate a rod or a bar to prevent movement of the link-lock power work device.

12. The product of claim 10 wherein the first stop arm and the second stop arm are attached to the work arm assembly in opposite directions and are constructed and arranged to align with the first shock absorber and the second shock absorber;
wherein each of the first stop arm and second stop arm have a plurality of mounting holes formed there through at regular intervals, at least a first fastener extending through one of the mounting holes in the first stop arm and attaching the first stop arm to the work arm, and at least a second fastener extending through one of the mounting holes in the second stop arm and attaching the second stop arm to the work arm; and
wherein the first housing side plate includes a first work access hole formed there through to provide access to the first fastener and the second housing side plate includes a second work access hole formed there through to provide access to the second fastener.

13. The product of claim 10 wherein the actuator includes an actuator housing, and wherein the actuator housing receives and projects the actuator shaft which drives the link-lock power work device to rotate the work arm assembly to either a vertical or horizontal position.

14. The product of claim 8 wherein the support bracket includes a bottom structure, and a first and a second arm structure;
wherein the bottom structure includes a bottom face, a top face, a first side face, a second side face, and a front face;
wherein the first and the second arm structures each include a front face, a rear face, a first side face, a second side face, and a top face;
wherein the first and the second arm structures extend upward at an acute angle from the bottom structure; and
wherein an engagement plate is attached to the top surface of the bottom structure and is constructed and arranged to accommodate a side edge of the first link plate and a side edge of the second link plate.

15. The product of claim 8 wherein the first side plate and the second side plate are triangular in shape and each include a cutout adjacent the first edge which is constructed and arranged to mate with a housing side plate.

16. A method comprising:
providing a link-lock power work device;
wherein an actuator drives a link-lock power work arm assembly in the link-lock power work device by protruding and retracting an actuator shaft which straightens and retracts causing the work arm assembly to rotate in a horizontal or vertical position; and
wherein a first stop arm engages a first shock absorber when the work arm assembly is in a horizontal position and wherein a second stop arm engages a second shock absorber when the work arm is in a vertical position.

17. The method of claim 16 wherein each of the first stop arm and second stop arm have a plurality of mounting holes formed there through at regular intervals so that the stop arms can be set at different positions.

18. The method of claim 16 wherein the link-lock power work device includes a lockout feature which prevents the link-lock power work device from operating.

19. The method of claim 16 wherein a tool is attached to the link-lock power work device work arm assembly and wherein the tool is in a raised position when the work arm assembly is in a vertical position and the tool is in a lowered position when the work arm assembly is in a horizontal position.

20. A product comprising a housing side plate for use in a power work device having a first corner, a second corner, and a third corner;
wherein the first corner is rounded, the second corner is rounded, and the third corner forms an angle;
wherein a first side edge extends from the first corner to the second corner, and a second side edge extends from the second corner to a third side edge;
wherein the second side edge and third side edge form an obtuse angle;
wherein a fourth side edge extends from the third corner and engages a fifth side edge which extends from the first corner;
wherein a pivot rod through-hole is formed adjacent the first corner;
wherein a first pair of mounting through-holes are formed in a first face of the housing side plate adjacent the pivot rod through-hole;
wherein a shaft through-hole is formed in the housing side plate adjacent the second corner;
wherein a second pair of mounting through-holes is formed in the first face adjacent the shaft through-hole;
wherein a work access through-hole extends through the housing side plate adjacent the shaft through-hole;
wherein a first set of mounting through-holes is located near a center of the housing side plate and which are constructed and arranged for mounting an angle bracket;
wherein a second set of mounting through-holes are located adjacent the first side edge and which are constructed and arranged for mounting a link-lock base assembly side plate;
wherein a third set of mounting through-holes is located adjacent the fourth and fifth side edges and which are constructed and arrange to mount a support plate; and
wherein a lockout through-hole is located adjacent the work access through-hole.
